(19) United States
(12) Patent Application Publication
(10) Pub. No.: US 2018/0155539 A1
(43) Pub. Date: Jun. 7, 2018

(54) Elastomer Composition for an Insert for Supporting a Wheel Tyre, Insert Comprising the Composition and Mounted Assembly Incorporating the Insert

(71) Applicant: Hutchinson, Paris (FR)

(72) Inventors: Hélène Delaunay, Villemandeur (FR); Nicolas Garois, Amilly (FR); Norbert Gangloff, Ladon (FR); Paul Nicolle, Montargis (FR); Natacha Carniol, Amilly (FR)

(73) Assignee: Hutchinson, Paris (FR)

(21) Appl. No.: 15/568,339

(22) PCT Filed: Apr. 27, 2015
(86) PCT No.: PCT/FR2015/051136

§ 371 Date: Oct. 20, 2017

(51) Int. Cl. C08L 53/02; C08L 51/00; C08J 9/32; B60C 7/10

(52) U.S. Cl. CPC C08L 53/025; C08L 51/006; C08J 9/32; B60C 7/105; C08L 2207/04; C08J 2477/00; C08L 2205/08; C08J 2203/22; C08J 2205/052; C08J 2351/00; C08J 2353/02; C08L 2205/03

(57) ABSTRACT

The invention concerns an elastomer composition for a self-supporting insert (1) intended to support a tyre of a wheel of a vehicle, an insert of which at least one layer (3) comprises said composition and a mounted assembly incorporating said insert. The invention applies to a non-pneumatic mounted assembly, in particular for a vehicle with two wheels, in which each of the tyres is permanently supported by said insert, The elastomer composition comprises, principally by mass, a mixture of at least one first thermoplastic elastomer and at least one second thermoplastic elastomer, and said composition is such that said at least one first thermoplastic elastomer is a copolyamide (COPA) and said at least one second thermoplastic elastomer is a thermoplastic styrene (TPS) elastomer.

The present invention relates to an elastomeric composition for a self-supporting insert intended to support a tire of a vehicle wheel, to an insert of which at least one layer comprises this composition and to a fitted assembly incorporating this insert. The invention applies to a non-pneumatic fitted assembly (i.e. without inflation pressure) especially but not uniquely for a two-wheeled vehicle, each of the tires of which is supported permanently by this insert.

As is known, the fitted assemblies for two-wheeled vehicles may incorporate means for pressurizing their internal space, whether this is via air chambers provided between the pneumatic tire and the wheel rim (such a fitted assembly is then referred to as a “tube type” assembly) or else with no air chamber via the airtight fitting of the pneumatic tire against the rim flanges (“tubeless” fitted assembly).

One drawback of these pneumatic fitted assemblies (i.e. that are under internal pressure) lies not only in the regular inflation that they require in order to compensate for the gradual leakage of the inflation gas, but also in the fact that they may be perforated, for example by a puncture or by vandalism which usually results in the immobilization of the vehicle for the repair thereof.

It is also known to use non-pneumatic tires that form a tread for the fitted assembly of a two-wheeled vehicle and that are supported without inflation gas by a compact or cellular self-supporting elastomer insert that fills the space between the tire and the rim.

For example, mention may be made of document WO-A1-2007/015279 for the description of such a non-pneumatic fitted assembly, in which the insert is based on one or more thermoplastic elastomers comprising exclusively or predominantly by weight a thermoplastic polyurethane (TPU) and optionally a styrenic thermoplastic elastomer (TPS) in a very minor amount by weight relative to the TPU.

One major drawback of this fitted assembly having a support insert based on a TPU lies in its relatively low endurance and in its relatively high rolling resistance.

Mention may also be made of document FR-B1-2 963 353 in the name of the applicant which has overcome this drawback by proposing a support insert for example for a non-pneumatic tire, the insert being of cellular type with closed cells. The insert presented in that document also comprised a TPU predominantly by weight but additionally another thermoplastic elastomer that may be a copolyamide (COPA) and/or a copolyester (COPE) and that interacts favorably with the TPU.

In the course of its recent intensive research, the applicant has sought to further improve the dynamic properties of the elastomer inserts for non-pneumatic tires, one objective of the present invention thus being to propose an elastomeric composition of compact type or of cellular type with closed cells for an insert intended to permanently support a non-pneumatic tire of a vehicle wheel, which makes it possible in particular to optimize the resilience of the insert incorporating this composition by adapting it to the dynamic stresses when rolling.

This objective is achieved in that the applicant has just surprisingly discovered that the selection of at least one COPA specifically combined with at least one TPS makes it possible to obtain a thermoplastic elastomer blend that acts as a basis for a self-supporting insert composition for a non-pneumatic tire which has in particular an improved resilience compared to that of the aforementioned inserts from the prior art based on a TPU, this resilience giving the inserts of the invention a dynamic behavior that is progressive starting from moving off and adapted to the stresses when rolling, without adversely affecting their endurance and their rolling resistance.

In other words, an elastomeric composition according to the invention for a self-supporting support insert for a non-pneumatic tire of a wheel is such that the composition, which may be of compact type or else cellular type with closed cells, comprises predominantly by weight a blend of at least one first thermoplastic elastomer and of at least one second thermoplastic elastomer, and the composition is characterized in that said at least one first thermoplastic elastomer is a COPA and said at least one second thermoplastic elastomer is a TPS.

The term “self-supporting” is understood in a known manner to mean an insert capable of permanently supporting the non-pneumatic tire without other means (e.g. without inflation gas or inner tube).

It will be noted that the present invention demonstrates an unexpected synergy effect between COPA and TPS thermoplastic elastomers, which makes it possible to improve the resilience of the composition based on these elastomers and to provide a progressive spring effect during stresses when rolling.

It will also be noted that this blend of COPA and TPS which characterizes the compositions according to the invention has the advantage of imparting a relatively low weight to the corresponding inserts (due to the low mean density of the thermoplastic elastomers used) and also of minimizing the creep of these compositions once converted.

It will additionally be noted that this COPA/TPS thermoplastic blend has the advantage of making the inserts of the invention completely recyclable and easily convertible for the processing thereof (no crosslinking being required).

Advantageously, said blend may comprise said at least one first thermoplastic elastomer in a weight fraction of less than or equal to that of said at least one second thermoplastic elastomer in said blend.

More advantageously still, said composition may be free of thermoplastic polyurethane (TPU), the weight fractions in said blend of said at least one first thermoplastic elastomer and of said at least one second thermoplastic elastomer possibly being respectively between 5% and 49% and between 95% and 51%.

Preferably, said at least one second thermoplastic elastomer comprises one said TPS of linear block type and one said TPS of block type grafted by a compatibilizing agent.

Even more preferably, said linear TPS and said grafted TPS are respectively present in said at least one second thermoplastic elastomer in weight fractions of between 40% and 60% and 60% and 40%, and are each selected independently from the group consisting of styrene-butadiene-styrene (SBS), styrene-isoprene-styrene (SIS), styrene-butylene-ethylene-styrene (SEBS) and styrene-ethylene-propylene-styrene (SEPS) block copolymers.

More preferably still, said linear TPS is an SEBS and said grafted TPS is an SEBS grafted by maleic anhydride constituting said compatibilizing agent (for example with a weight content of grafted maleic anhydride of between 1% and 2%).

Advantageously, said composition may comprise:
in a weight fraction of between 3% and 40%, said at least one first thermoplastic elastomer that comprises at least one polyether-block-amide (PEBA, e.g. having the name “Pebax” or “Vestamid” and having a Shore A hardness for example of between 60 and 90),
in a weight fraction of between 65% and 40%, said at least one second thermoplastic elastomer that preferably comprises one said TPS of linear type having a high molecular weight and one said TPS of the type grafted by a compatibilizing agent (e.g. two respectively linear and grafted SEBS each having a weight content of bound styrene of between 30% and 35% and a Shore A hardness of between 60 and 80), and
in a weight fraction of between 20% and 32%, a plasticizer, preferably a paraffinic plasticizer, that makes it possible to facilitate the mixing and processing of said composition.

According to another aspect of the invention, said composition may advantageously have a rebound resilience, measured according to the ISO 4662:2009 standard, which is greater than or equal to 70%, for example equal to 75%.

According to a first exemplary embodiment of the invention, said composition is compact, being free of blowing agent.

According to a second exemplary embodiment of the invention, said composition is cellular with closed cells, comprising a blowing agent in a weight fraction of between 1% and 20% preferably in the form of thermoplastic microspheres containing a blowing gas forming said blowing agent.

It will be noted that the expansion may as a variant be achieved by injecting a suitable gas (e.g. nitrogen or carbon dioxide) into the device used for obtaining the insert.

It will also be noted that the cellular structure obtained for the insert makes it possible to give it a stiffness and a mass that are relatively low compared to those obtained by compact elastomer materials.

Generally, with reference to all of the aforementioned exemplary embodiments of the invention, said composition may optionally contain, besides the COPA/TPS thermoplastic blend and said plasticizer, all or some of the other additives customarily used in thermoplastic elastomer blends, such as for example organic reinforcing fillers (e.g. carbon blacks) or inorganic reinforcing fillers (e.g. chalk or kaolin) and/or fibers (e.g. reinforcing textile fibers for example based on a polyamide). These fillers may indeed make it possible to improve, on the one hand, the load-bearing capacity (or load-bearing strength when rolling) of the insert and, on the other hand, its breaking strength.

A self-supporting support insert according to the invention for a non-pneumatic tire of a vehicle wheel, the insert having a circumferential length and a radial thickness rendering it suitable to be fitted between the wheel and the tire while permanently supporting the latter, the insert comprising, over its length, at least one first layer having a radial thickness of greater than 2 mm, is such that said at least one first layer consists of said composition defined above.

It will be noted that an insert according to the invention may be obtained either by extrusion or by co-injection molding.

Advantageously, the insert may have a substantially circular cross section delimited radially on the outside by a second outer layer having a radial thickness of between 100 μm and 1 mm and consisting of a crosslinked elastomer composition.

It will be noted that this crosslinked outer layer should not be confused with a film (which by definition has a thickness of less than 100 μm) and helps the insert to obtain its self-supporting nature.

More advantageously still, this crosslinked elastomeric composition may comprise predominantly by weight at least one third thermoplastic elastomer selected from thermoplastic vulcanizates (TPVs, for example such as the crosslinked elastomers with thermoplastic conversion described in examples 1 to 4 of patent EP-B1-0 840 763 in the name of the applicant which comprise at least one elastomer with polymerization by a metallocene catalyst and a grafted polyolefin, it being specified that other TPVs can also be used), crosslinked copolyesters (COPEs) and blends thereof, this crosslinked composition preferably comprising in addition a thermosetting resin such as an epoxy resin dispersed in said at least one third thermoplastic elastomer, especially in the case where the latter comprises one or more COPEs.

According to a first embodiment of the invention, the insert is hollow over said length and has a tubular geometry comprising one said first layer which is optionally radially the innermost for the insert and which is preferably compact, and said second outer layer.

It will be noted that this first layer, if it is the innermost for the insert, may advantageously have a radial thickness of between 5 mm and 15 mm and preferably between 6 mm and 10 mm, e.g. for a bicycle tire.

According to a second embodiment of the invention, the insert is solid over said length and has a cellular core with closed cells, one said first intermediate layer which is preferably compact surrounding said core, and said second outer layer.

This first intermediate layer may have a radial thickness of between 2 mm and 5 mm, e.g. for a bicycle.

A non-pneumatic fitted assembly according to the invention for a wheeled vehicle, in particular selected from bicycles, motorcycles, handling vehicles, wheelchairs and rollators, the fitted assembly comprising a wheel, a non-pneumatic tire fitted on the wheel that comprises a tread and two beads fitted against two edges of the wheel, and a self-supporting support insert for the tire that is fitted between the wheel and the tire while permanently supporting the latter, is characterized in that the insert is as defined above.

This fitted assembly according to the invention especially has the following advantages, in addition to those mentioned above:
effective protection against the risks of perforation of the tire, impact-pinch when rolling or vandalism,
comfort, road-holding and service life qualities that are satisfactory for the user, and
very simple fitting of the insert inside the tire, with no particular equipment other than suitable “tire levers”.

Other features, advantages and details of the present invention will emerge on reading the following description of several exemplary embodiments of the invention given by way of illustration and non-limitingly, the description being given with reference to the appended drawings, among which:

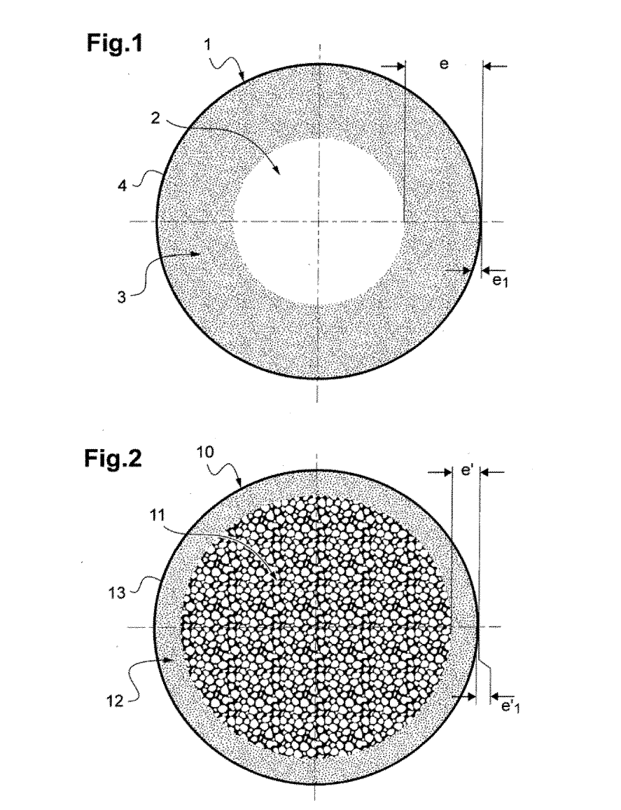

FIG. 1 is a cross-sectional view of a tubular insert according to said first embodiment of the invention,

FIG. 2 is a cross-sectional view of a solid insert according to said second embodiment of the invention, and

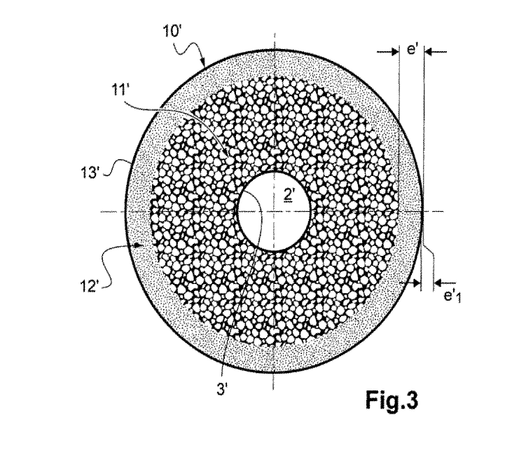

FIG. 3 is a cross-sectional view of a tubular insert according to said first embodiment, in accordance with a variant of FIG. 1.

The inserts 1, 10, and 10′ from FIGS. 1, 2 and 3 are intended to be positioned between a wheel rim and a non-pneumatic tire (which are not illustrated) so as to form a fitted assembly without inflation gas for example for a two-wheeled vehicle such as a bicycle, it being specified that these inserts 1, 10, and 10′ may be used with different shapes and/or dimensions in order to equip non-pneumatic fitted assemblies of other vehicles such as those mentioned above, in a nonlimiting manner.

The tubular insert 1 from FIG. 1 is thus intended to delimit a non-inflated internal space 2, and it is formed:
of a compact inner layer 3 which has an annular cross section and which consists of a compact thermoplastic elastomer composition according to the invention, i.e. the elastomer matrix of which is based on a blend comprising at least one COPA and at least one TPS, and
of a compact outer layer 4 or “skin” covering the inner layer 3 over the whole of its circumference and its length and which consists of a crosslinked thermoplastic elastomer composition according to the invention, i.e. the elastomer matrix of which is based on at least one TPV and/or on at least one crosslinked COPE.

In the example from FIG. 1 showing an insert 1 at rest for a bicycle wheel (enlargement of around ×3), the inner layer 3 has a thickness of 7.5 mm and the outer layer 4 a thickness e₁ of 0.5 mm (hence a thickness e of 8 mm for the layers 3 and 4), with internal and external diameters of the insert 1 respectively of 17.5 mm and 33.5 mm.

The solid insert 10 of rod type from FIG. 2 is formed:
of an expanded core 11 of cellular type with closed cells which constitutes the major part, by volume, of the insert 10 and which consists for example of a cellular thermoplastic elastomer composition according to the invention, i.e. based on at least one COPA and on at least one TPS,
of a compact intermediate layer 12 which covers the expanded core 11 over the whole of its circumference and its length and which consists of a compact thermoplastic elastomer composition according to the invention based on at least one COPA and on at least one TPS, and
a compact outer layer 13 similar to that from FIG. 1 which consists of a crosslinked thermoplastic elastomer composition based on at least one TPV and/or on at least one crosslinked COPE.

In the example from FIG. 2 that illustrates an insert 10 at rest for a bicycle wheel (enlargement of around ×3), the intermediate layer 12 has a thickness of 2.5 mm and the outer layer 13 a thickness e′₁ of 0.5 mm (hence a thickness e′ of 3 mm for the layers 12 and 13), with an external diameter of the insert 10 of 33.5 mm.

The tubular insert 10′ from FIG. 3 is formed:
of a compact inner layer 3′ or “skin” which externally delimits a non-inflated internal space 2′ while having an annular cross section and which consists of a crosslinked thermoplastic elastomer composition based on at least one TPV and/or on at least one crosslinked COPE,
of an expanded tubular core 11′ of cellular type with closed cells which constitutes the major part, by volume, of the insert 10′ and which consists for example of a cellular thermoplastic elastomer composition according to the invention, i.e. based on at least one COPA and on at least one TPS,
of a compact intermediate layer 12′ which covers the expanded core 11′ over the whole of its circumference and its length and of a compact thermoplastic elastomer composition according to the invention based on at least one COPA and on at least one TPS, and
a compact outer layer 13′ or “skin” similar to the inner layer 3′ which consists which consists of a crosslinked thermoplastic elastomer composition based on at least one TPV and/or on at least one crosslinked COPE.

In the example from FIG. 3 showing an insert 10′ at rest for a bicycle wheel, the inner layer 3′ and outer layer 13′ each have a same thickness e′₁ of 0.50 mm (with a total thickness e′ of 3 mm for the layers 12′ and 13′ as for the insert 10 from FIG. 2), the insert 10′ having an external diameter of 33.5 mm.

Each of the elastomeric compositions forming the layers 3, 4, 11, 12, 13 and 3′, 11′, 12′, 13′ were obtained essentially in two steps:
a first step of thermomechanical working of each composition, optionally with addition of a blowing agent, preferably in the form of thermoplastic microspheres containing a blowing gas, and
a second step of shaping by extrusion (processing in a standard extrusion line comprising extrusion, cooling and cutting stations) or by co-injection molding in a mold.

The extruded or co-injection molded self-supporting insert 1, 10, 10′ was finally inserted inside the non-pneumatic tire fitted to the wheel.

Examples of compositions that can be used for inserts according to invention:

### 1) Inner Layer or Intermediate Layer Compositions:

Two compact thermoplastic elastomer compositions I1 and I2 that can be used for the inner layer 3 of the insert 1, the intermediate layer 12 of the insert 10 and the intermediate layer 12′ of the insert 10′ were prepared as indicated above, which were both based on a COPA of PEBA type and on a blend of two TPSs of SEBS type (the formulations below are expressed in parts by weight), and the rebound resiliences obtained for I1 and I2 were measured according to the ISO 4662:2009 standard.

Composition I1:

| Pebax 4033 PEBA | 10 parts |
|---|---|
| Kraton G1651 SEBS | 50 parts |
| Kraton FG1901 MAH-grafted SEBS | 50 parts |
| Torilis 7200 paraffinic plasticizer | 50 parts |
| Resilience obtained | 75%. |

It will be noted that the resilience obtained for this composition I1 comprising TPSs and a COPA in respective weight fractions of 63% and 6% is very high, which advantageously makes it possible to give an insert 1, 10, 10′ according to the invention incorporating it a dynamic behavior that is progressive starting from moving off and adapted to the stresses when rolling.

Composition I2:

| Pebax 4033 PEBA | 75 parts |
|---|---|
| Kraton G1651 SEBS | 50 parts |
| Kraton FG1901 MAH-grafted SEBS | 50 parts |
| Torilis 7200 plasticizer | 50 parts |
| Resilience obtained | 70%. |

It will be noted that the high resilience obtained for this composition I2 comprising TPSs and a COPA in respective weight fractions of 44% and 33% also makes it possible to give an insert 1, 10, 10′ according to the invention incorporating it this progressive resilient dynamic behavior that is adapted to the stresses when rolling.

### 2) Outer Layer Compositions:

Two crosslinked thermoplastic elastomer compositions I3 and I4 that can be used for the outer layers 4 and 13 of the inserts 1 and 10 and for the inner layer 3′ and outer layer 13′ of the insert 10′ were prepared as indicated above, which were respectively based on a TPV of EPDM-PP type (of “Vegaprene®”) for the composition I3 and based on a blend of two COPEs reinforced by a thermosetting resin for the composition I4 (the formulations below are also expressed in parts by weight).

Composition I3:

| | | |
|---|---|---|
| EPDM: VISTALON 3666 | 91.4 | parts |
| Polypropylene: Finapro PPH 3060 | 170 | parts |
| Activator: stearic acid | 0.5 | part |
| Activator: active ZnO | 3 | parts |
| Processing aid: PEG 4000 | 5 | parts |
| Processing aid: Polyplastol | 1 | part |
| Processing aid: Crodamide E | 1 | part |
| Phenolic resin: SP 1055 resin | 6 | parts |
| Carbon black: FEF 550 | 22 | parts |
| Plasticizer: Torilis 7200 | 24.8 | parts |

Composition I4:

| | |
|---|---|
| COPE: Arnitel PM460 | 100 parts |
| Epoxy resin: DER330 | 5 parts |
| Crosslinking agent: Jeffamine T403 | 2 parts |

The running tests carried out by the applicant on the basis of these compositions showed that these compositions I3, I4 of inner layers 4, 13, 3′, 13′ according to the invention contribute significantly to making the insert 1, 10, 10′ self-supporting when rolling.

Generally, it will be noted that these formulations I1, I2 of inner or intermediate layers and I3, I4 of outer layers of inserts according to the invention are given by way of example and non-limitingly, and that it is in particular possible to use COPAs other than the PEBAs tested for these inner and intermediate layers, and/or TPVs or COPEs other than those tested for these outer layers.

1. An elastomeric composition for a self-supporting support insert for a non-pneumatic tire of a vehicle wheel, the composition comprising predominantly by weight a blend of at least one first thermoplastic elastomer and of at least one second thermoplastic elastomer, wherein said at least one first thermoplastic elastomer is a copolyamide (COPA) and said at least one second thermoplastic elastomer is a styrenic thermoplastic elastomer (TPS).

2. The elastomer composition as claimed in claim 1, wherein said blend comprises said at least one first thermoplastic elastomer in a weight fraction of less than or equal to that of said at least one second thermoplastic elastomer in said blend.

3. The elastomer composition as claimed in claim 2, wherein the composition is free of thermoplastic polyurethane (TPU), the weight fractions in said blend of said at least one first thermoplastic elastomer and of said at least one second thermoplastic elastomer being respectively between 5% and 49% and between 95% and 51%.

4. The elastomer composition as claimed in claim 1, wherein said at least one second thermoplastic elastomer comprises one said TPS of linear block type and one said TPS of block type grafted by a compatibilizing agent.

5. The elastomer composition as claimed in claim 4, wherein said linear TPS and said grafted TPS are respectively present in said at least one second thermoplastic elastomer in weight fractions of between 40% and 60% and 60% and 40%, and are each selected independently from the group consisting of styrene-butadiene-styrene (SBS), styrene-isoprene-styrene (SIS), styrene-butylene-ethylene-styrene (SEBS) and styrene-ethylene-propylene-styrene (SEPS) block copolymers.

6. The elastomer composition as claimed in claim 5, wherein said linear TPS is an SEBS and said grafted TPS is an SEBS grafted by maleic anhydride constituting said compatibilizing agent.

7. The elastomer composition as claimed in claim 1, wherein the composition comprises:
in a weight fraction of between 3% and 40%, said at least one first thermoplastic elastomer that comprises at least one polyether-block-amide (PEBA),
in a weight fraction of between 65% and 40%, said at least one second thermoplastic elastomer that preferably comprises one said TPS of linear type and one said TPS of the type grafted by a compatibilizing agent, and
in a weight fraction of between 20% and 32%, a plasticizer, preferably a paraffinic plasticizer.

8. The elastomer composition as claimed in claim 1, wherein the composition has a rebound resilience, measured according to the ISO 4662:2009 standard, which is greater than or equal to 70%, for example equal to 75%.

9. The elastomer composition as claimed in claim 1, wherein the composition is compact, being free of blowing agent.

10. The elastomer composition as claimed in claim 1, wherein the composition is cellular with closed cells, comprising a blowing agent in a weight fraction of between 1% and 20% preferably in the form of thermoplastic microspheres containing a blowing gas forming said blowing agent.

11. A self-supporting support insert for a non-pneumatic tire of a vehicle wheel, the insert having a circumferential length and a radial thickness rendering it suitable to be fitted between said wheel and said tire while permanently supporting the latter, the insert comprising, over said length, at least one first layer having a radial thickness of greater than 2 mm, wherein said at least one first layer consists of a elastomer composition as claimed in claim 1.

12. The self-supporting support insert as claimed in claim 11, wherein the insert has a substantially circular cross section delimited radially on the outside by a second outer layer having a radial thickness of between 100 μm and 1 mm and consisting of a crosslinked elastomeric composition.

13. The self-supporting support insert as claimed in claim 12, wherein said crosslinked elastomeric composition comprises predominantly by weight at least one third thermoplastic elastomer selected from thermoplastic vulcanizates (TPVs), crosslinked copolyesters (COPEs) and blends thereof, said crosslinked elastomeric composition preferably comprising in addition a thermosetting resin such as an epoxy resin dispersed in said at least one third thermoplastic elastomer, especially in the case where the latter comprises one or more COPEs.

14. The self-supporting support insert as claimed in claim 12, wherein the insert is hollow over said length and has a tubular geometry comprising one said first layer which is preferably compact, and said second outer layer.

15. The self-supporting support insert as claimed in claim 12, wherein the insert is solid over said length and has a cellular core with closed cells, one said first intermediate layer which is preferably compact surrounding said core, and said second outer layer.

16. A non-pneumatic fitted assembly for a wheeled vehicle selected from bicycles, motorcycles, handling vehicles, wheelchairs and rollators, the fitted assembly comprising a wheel, a non-pneumatic tire fitted on the wheel that comprises a tread and two beads fitted against two edges of the wheel, and a self-supporting support insert for the tire that is fitted between the wheel and the tire while permanently supporting the latter, wherein said self-supporting support insert is as defined in claim 11.
